(19) United States
(12) Patent Application Publication
(10) Pub. No.: US 2012/0182125 A1
(43) Pub. Date: Jul. 19, 2012

(54) PASSWORD CHECKING DEVICE

(75) Inventor: XIANG CAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/108,995

(22) Filed: May 17, 2011

(30) Foreign Application Priority Data
Jan. 13, 2011 (CN) 201110006671.5

(51) Int. Cl. G06F 7/04

(52) U.S. Cl. 340/5.85

(57) ABSTRACT

A password checking device is connected to a power pushbutton. The power pushbutton includes a first terminal connected to a power on terminal of an electronic device and a second terminal configured for being connected to ground. The password checking device includes a touch pushbutton, a capacitive touch sensor, a switching circuit, and a processor. The touch pushbutton includes a metal cover pressed down by the power pushbutton and a metal spring receiving the power pushbutton. The capacitive touch sensor senses the capacitance of the touch pushbutton. When the capacitance changes, the sensor sends a counting signal. The processor is pre-set with a password with the times of the counting signal and an interval between two counting signals. The processor controls the switching circuit make sure the second terminal is connected to ground.

### BACKGROUND

1. Technical Field

The present disclosure relates to a password checking device.

2. Description of Related Art

In computer security, mechanical locks and fingerprint locks are often used to protect a computer. However, the keys of the mechanical locks are easily lost, and the fingerprint locks are expensive.

What is needed, therefore, is a password checking device capable of overcoming the described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a schematic view of a touch pushbutton and a power pushbutton of a password checking device according to an exemplary embodiment.

FIG. 2 is a block diagram of one embodiment of the password checking device.

FIG. 3 is a circuit diagram of one embodiment of the password checking device.

### DETAILED DESCRIPTION

Embodiments of the present disclosure are described in detail as follows, with reference to the accompanying drawings.

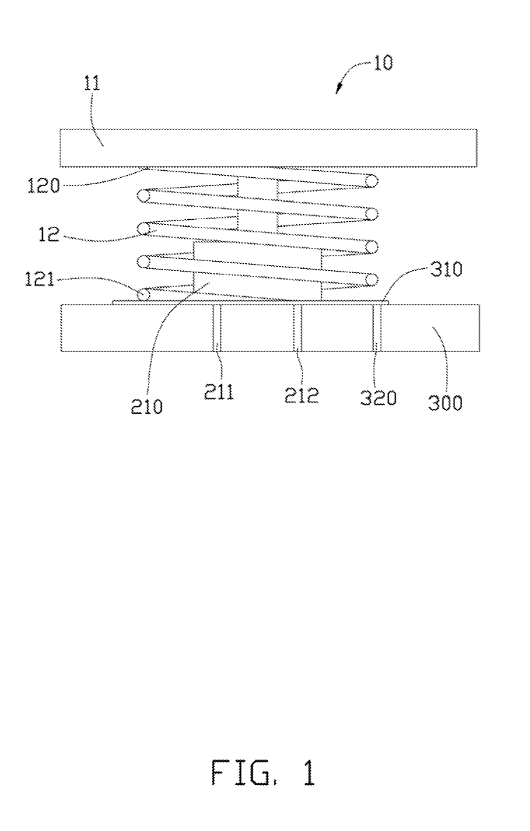

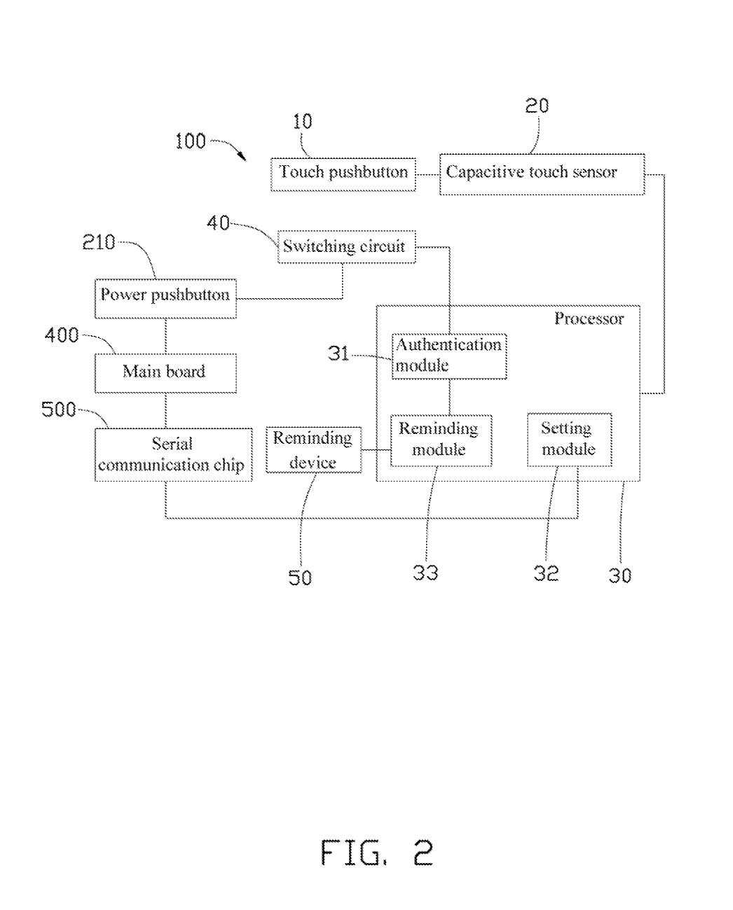

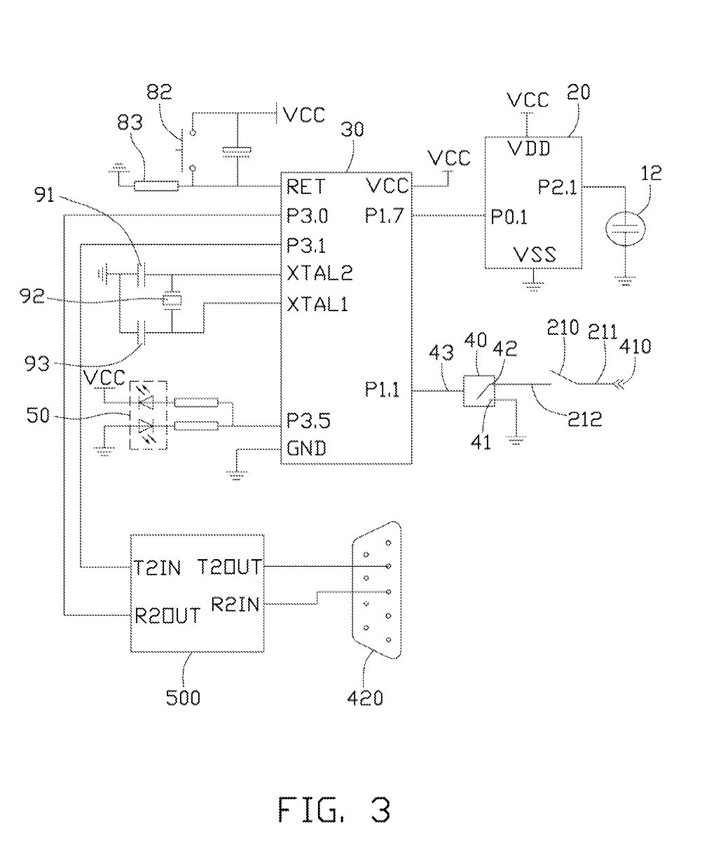

Referring to FIGS. 1-3, a password checking device 100, according to an exemplary embodiment is shown. The password checking device 100 can be mounted onto a computer (not shown). The password checking device 100 is electrically connected to a power pushbutton 210 of the computer. The password checking device 100 includes a touch pushbutton 10, a capacitive touch sensor 20, a processor 30, a switching circuit 40, and a reminding device 50.

The touch pushbutton 10 is electrically connected to the capacitive touch sensor 20. The switching circuit 40 is electrically connected to the power pushbutton 210 of the computer. The processor 30 is electrically connected to the capacitive touch sensor 20, the switching circuit 40, and the reminding device 50. In addition, the processor 30 is electrically connected to a main board 400 of the computer via a serial communication chip 500.

The touch pushbutton 10 includes a metal cover 11 and a metal spring 12. In the present embodiment, the touch pushbutton 10 is fixed on a circuit board 300. The circuit board 300 includes a ring-shaped copper foil 310 and a number of leads 320. The ring-shaped copper foil 310 is positioned on the upper surface of the circuit board 300. The ring-shaped copper foil 310 is electrically connected to the leads 320. The metal spring 12 includes a resisting end 120 and a connecting end 121 opposite to the resisting end 120. The metal cover 11 is fixed on the resisting end 120. The connecting end 121 can be connected to the ring copper foil 310 by a soldering process. When the metal cover 11 is touched by a hand, the capacitance of the metal spring 12 changes.

The power pushbutton 210 is received in the metal spring 12. The power pushbutton 210 is capable of being pressed down by the metal cover 11. In the present embodiment, the power pushbutton 210 includes a first terminal 211 and a second terminal 212. The first terminal 211 and the second terminal 212 are soldered onto the circuit board 300. The first terminal 211 is electrically connected to a power on signal terminal 410. The second terminal 212 is electrically connected to the switching circuit 40. The switching circuit 40 controls the second terminal 212, which is selectively grounded. If the second terminal 212 is connected to ground, and the power on pushbutton 210 is pressed down to make the first terminal 211 electrically connect to the second terminal 212 at the same time, the power on signal terminal 410 can be connected to ground to turn on the computer.

The capacitive touch sensor 20 senses whether the capacitance of the touch pushbutton 10 is changed. When the capacitance of the touch pushbutton 10 is changed, the capacitive touch sensor 20 sends a counting signal. In the present embodiment, the capacitive touch sensor 20 can be a CY8C21334 chip. A terminal P2.1 of the capacitive touch sensor 20 is electrically connected to the metal spring 12 by the leads 320 and the ring-shaped copper foil 310. A terminal P0.1 of the capacitive touch sensor 20 is electrically connected to the processor 30.

In the present embodiment, the processor 30 can be a PIC16F73 microcontroller. A terminal P1.7 of the processor 30 is electrically connected to the terminal P0.1 of the capacitive touch sensor 20. A terminal P1.1 of the processor 30 is electrically connected to the switching circuit 40. A terminal P3.5 of the processor 30 is electrically connected to the reminding device 50. An end of a capacitor 91 and an end of a crystal oscillator 92 are both connected to a terminal XTAL2 of the processor 30. The other end of the capacitor 91 is connected to ground. An end of a capacitor 93 and the other end of the crystal oscillator 92 are both electrically connected to a terminal XTAL1 of the processor 30. The other end of the capacitor 93 is connected to ground. The crystal oscillator 92 offers a clock frequency to the processor 30. A terminal P3.0 and a terminal P3.1 of the processor 30 are respectively connected to a terminal T2 IN and a terminal R2 OUT of the serial communication chip 500 for communicating with the main board 400. The serial communication chip 500 can be an IC MAX 232 chip. A terminal T2 OUT and a terminal R2 IN of the serial communication chip 500 are electrically connected to a COM interface 420 of the main board 400. An end of a capacitor 81, an end of a switch 82, and an end of a resistor 83 are electrically connected to a RET terminal of the processor 30. The other end of the capacitor 81 and the other end of the switch 82 are electrically connected to a voltage source VCC. The other end of the resistor 83 is electrically connected to ground. If the switch 82 is closed, the processor 30 will be reset.

The processor 30 pre-sets a password defined by the times of the counting signal and spacing intervals between two sequential counting signals. The processor 30 includes an authentication module 31, a setting module 32 and a reminding module 33. The authentication module 31 determines whether the times of the counting signal and spacing intervals between two sequential counting signals from the capacitive touch sensor 20 is same as the pre-set password. In the present embodiment, the password can be a four digit number password, but it should be understood that other combinations of digits, letters, and symbols may be used with equal applicability. The processor 30 receives the counting signal from the capacitive touch sensor 20. If the spacing interval between two counting signals is less than 3 seconds, the counting signals will be defined as a group of signals, the times of the counting signals in a group is defined as a digit. If the spacing interval between a backward counting signal and a forward counting signal is more than 3 seconds, the backward counting signal will be defined as a next group of signals. The processor 30 also pre-sets a locking time. In the present embodiment, the locking time is 5 seconds. If the password does not match with the pre-password or the spacing intervals is more than the locking time, the authentication module 31 will send the second signal to the switching circuit 40, thereby the second terminal 212 is disconnected from ground by the switching circuit 40.

The setting module 32 is used for setting the pre-password. In the present embodiment, the setting module 32 communicates with the main board 400 via the serial communication chip 500. The authorized user edits the pre-password with the computer communicating with the setting module 32.

The reminding module 33 controls the reminding device 50 to send a reminder. The reminder shows the lock state of the computer. In the present embodiment, the reminding module 33 controls the reminding device 50 to send a first reminder to show that the computer is unlocked. The reminding module 33 controls the reminding device 50 to send a second reminder to show that the computer is locked.

The switching circuit 40 makes the second terminal 212 of the power pushbutton 210 grounded or not grounded. In the present embodiment, the switching circuit 40 is an electromagnetic relay. The switching circuit 40 includes a third terminal 41, a fourth terminal 42, and a control terminal 43. The third terminal 41 is connected to ground. The fourth terminal 42 is electrically connected to the second terminal 212. The control terminal 43 is electrically connected to the terminal P1.1 of the processor 30 for receiving a control signal of the processor 30.

The reminding device 50 sends the first reminder and the second reminder according to the first and second signal from the authentication module 31. The first and second reminders can be a sound reminder, a light reminder, or an image reminder. In the present embodiment, the reminding device 50 is a dual-wavelength red/green light emitting diode with four terminals. The first reminder is a green light. The second reminder is a red light. Two terminals of the reminding device 50 are respectively connected to the voltage Vcc and ground. The other two terminals of the reminding device 50 are both connected to the terminal P3.5 of the processor 30.

When the capacitance of the touch pushbutton 10 is changed, the capacitive touch sensor 20 sends a counting signal to the processor 30. The terminal P1.7 of the processor 30 receives the counting signal from the capacitive touch sensor 20. The authentication module 31 determines whether the counting signal matches pre-set password. If the password is accepted, the authentication module 31 will send a first signal to the switching circuit 40 and the reminding module 33. The switching circuit 40 makes the second terminal 212 connect to ground, when the control terminal 43 receives the first signal. At this time, if the power pushbutton 210 is pressed, the power pushbutton 210 is capable of starting the computer. The terminal P3.5 of the processor 30 outputs a low level voltage to control the reminding device 50 to emit a green light, when the reminding module 33 receives the first signal from the authentication module 31.

If the password is not accepted, the authentication module 31 sends a second signal to the switching circuit 40 and the reminding module 33. The switching circuit 40 makes the second terminal 212 disconnect from ground, when the control terminal 43 receives the second signal. At this time, even the power pushbutton 210 is pressed, the power pushbutton 210 is incapable of starting the computer, because the second terminal 212 is disconnected from ground. That will prevent the computer from being started by an unauthorized user. The terminal P3.5 of the processor 30 outputs a high level voltage to control the reminding device 50 to emit a red light, when the reminding module 33 receives the second signal from the authentication module 31.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A password checking device connected to a power pushbutton of an electronic device, the power pushbutton comprising a first terminal connected to a power on terminal of the electronic device and a second terminal configured for being connected to ground, the password checking device comprising:
a touch pushbutton comprising:
a metal cover capable of being pressed down by the power pushbutton;
a metal spring having a resisting end and a connecting end, the metal spring receiving the power pushbutton, and the resisting end of the metal spring electrically connected to the metal cover;
a capacitive touch sensor electrically connected to the connecting end of the metal spring for sensing capacitance of the touch pushbutton, wherein when the capacitance of the touch pushbutton changes, the capacitive touch sensor sends a counting signal;
a switching circuit connected between the second terminal and ground;
a processor electrically connected to the capacitive touch sensor and the switching circuit, the processor pre-set with a password comprising the times of the counting signal and a spacing interval between two sequential counting signals, and the processor being configured for determining whether times of the counting signal and spacing intervals between two sequential counting signals from the capacitive touch sensor is same as the pre-set password, wherein if the password is accepted, the processor will control the switching circuit to make the second terminal electrically connect to ground, and if the password is not accepted, the processor controls the switching circuit to disconnect the second terminal from ground.

2. The password checking device as claimed in claim 1, wherein the processor comprises an authentication module configured for determining whether the number of the counting signal and the spacing interval between two sequential counting signals from the capacitive touch sensor is same as the pre-set password, if the password is accepted, the authentication module sends a first signal to the switching circuit.

3. The password checking device as claimed in claim 2, wherein if the number of the counting signal and the spacing interval between two sequential counting signals from the capacitive touch sensor do not match the pre-set password, the authentication module will send a second signal to the switching circuit for disconnecting the second terminal from ground.

4. The password checking device as claimed in claim 2, wherein the processor is pre-set with a locking time, if the spacing intervals between two sequential counting signals from the capacitive touch sensor is more the locking time, the authentication module will send a second signal to the switching circuit for cutting off the second terminal from ground.

5. The password checking device as claimed in claim 1, further comprising a reminding device electrically connected to the processor, wherein the reminding device sends a first reminder showing unlocking state, when the authentication module sends a first signal, the reminding device sends a second reminder showing a lock state of the password checking device, when the authentication module sends a second signal.

6. The password checking device as claimed in claim 5, wherein the processor comprises a reminding module configured for controlling the reminding device, the reminding module receives the first signal and the second signal from the authentication module, the reminding module controls the reminding device to send the first reminder, when the reminding module receives a first signal from the authentication module, the reminding module controls the reminding device to send the second reminder, when the reminding module receives a second signal from the authentication module.

7. The password checking device as claimed in claim 5, wherein the first reminder and the second reminder are selected one of a sound message, a light message and an image message.

8. The password checking device as claimed in claim 5, wherein the reminding device is a dual-wavelength red/green light emitting diode, the first reminder is a green light, the second reminder is a red light.

9. The password checking device as claimed in claim 1, wherein the processor comprises a setting module configured for setting the pre-set password.

10. The password checking device as claimed in claim 1, wherein the processor is a microcontroller.

11. The password checking device as claimed in claim 1, wherein the switching circuit is an electromagnetic relay.

12. The password checking device as claimed in claim 11, wherein switching circuit comprise a third terminal, a fourth terminal, and a control terminal, the third terminal is electrically connected to the second terminal, the fourth terminal is electrically connected to ground, the control terminal is electrically connected to the processor for receiving the first signal and the second signal, when the control terminal receives a first signal, the switching circuit makes the third terminal electrically connected to the fourth terminal, when the control terminal receives a second signal, the switching circuit disconnects the third terminal from the fourth terminal.
